(19) United States
(12) Patent Application Publication
(10) Pub. No.: US 2010/0127462 A1
(43) Pub. Date: May 27, 2010

(54) PISTON RING WITH A MULTILAYER ASSEMBLY, AND A METHOD FOR THE PRODUCTION THEREOF

(76) Inventors: Michael Buchmann, Stuttgart (DE); Peter Schmidt, Neunkirchen Seelscheid (DE); Marc-Manuel Matz, Friedberg (DE); Johann Riedl, Friedberg (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/522,413

(22) PCT Filed: Nov. 26, 2007
(86) PCT No.: PCT/EP07/10259

§ 371 Date: Jul. 8, 2009

(30) Foreign Application Priority Data
Jan. 9, 2007 (DE) 10 2007 001 377.0

(51) Int. Cl. F16J 9/26; C23C 4/10; F02F 5/00

(52) U.S. Cl. 277/444; 427/451

(57) ABSTRACT

The present invention relates to a piston ring with improved running-in and wear behaviour as well as to a method for the production thereof. According to a first embodiment, the piston ring comprises a ring body (2), an adhesive promoter layer (4) of a Ni-alloy applied to the bearing surface of the ring body (2) by thermal spraying, a wear-resistant coating (6) of a Mo-alloy with CrC, WC, MoC applied to the adhesive promoter layer (4) by thermal spraying; and a running-in layer (8) of an AlCu-alloy or Ni-graphite-alloy applied to the wear-resistant coating (6) by thermal spraying. According to a second embodiment, the piston ring comprises a ring body, an adhesion layer applied to the bearing surface of the ring body, and a running-in layer, comprising nickel graphite, that is applied to the adhesion layer.

The present invention relates to a piston ring and a method for the production thereof, particularly a large-bore piston ring with a multilayer coating for an internal combustion engine.

With piston rings as for example those of internal combustion piston engines there are two demands to be fulfilled which are per se conflicting. On the one hand, a high wear-resistance has to be present, because otherwise, i.e. with thinning piston ring, the gas leakage and the oil consumption could increase as well as the performance of the engine could decrease. By a wearing off piston ring the gap between cylinder wall and piston ring becomes bigger and bigger, so that combustion gases can easier escape past the ring (so-called blow-by) which reduces the efficiency of the engine. By an enlarged gap furthermore the not stripped oil film remaining in the combustion space becomes thicker, so that more oil per time unit can get lost, thus the oil consumption is increased.

To achieve as optimal as possible engine properties, thus to achieve the best possible compromise between maximum seal effect and low friction losses, hence the dimension of the gap between piston ring(s) and cylinder wall must be maintained as exactly as possible. However, this would require complex and expensive process steps in the production and assembly of the engine, because otherwise it always comes to a certain degree of inevitable tolerance. Normally, a perhaps slightly too small gap dimension is accepted, the piston ring being further allowed to achieve the optimum thickness by friction wear during operation. Ideally, the bearing surface of the piston ring wears off until the optimal gap diameter is achieved. This process is also called running-in.

On the one hand, a material as wear-resistant as possible is desired to achieve that the piston ring wears out as little as possible in the regular operation and the gap hardly increases. To achieve good running-in properties, however, at least a part of the bearing surface must be able to be rubbed off comparatively easily, so that a, perhaps (e.g., due to inevitable component tolerances) too small gap between piston ring and cylinder wall can extend as quickly as possible to the right dimension during the running-in operation.

Hence, in principle piston rings are provided with coatings which should produce the desired qualities. This is naturally easier to handle and cheaper as to produce the complete piston ring from a possibly expensive material with the desired properties. With such coatings another requirement comes along. In additional to providing the necessary qualities, the coating has also to have such composition that it does not separate from the piston ring, i.e. such that it exhibits good adhesion with the underlying material. Provided that the coating consists of several different layers, further a good coherence between the layers is necessary, that is, a good cohesion. Otherwise there is the danger of the formation of cracks or separation of the layers which can be dangerous for the engine.

Coatings on the bearing surfaces of piston rings have to be wear-resistant in the surface area being in contact with the cylinder wall. In addition, its own wear in the running-in phase should be sufficient for an adequate adjustment to the counter surface. Moreover, these layers should be highly resistant to breakouts and also exhibit no or only very slight fatigue even after long periods of use.

Wear-resistant coatings are produced, for example, of hard chrome. DE 199 31 829 A1 describes a galvanic hard chrome layer for a piston ring. Other materials for wear-resistant coatings are chrome with aluminium oxide ceramics (e.g., CKS® of the company Federal Mogul) or chrome with micro diamond (e.g., GDC® of the company Federal Mogul).

Running-in layers applied to CKS®-wear-resistant coatings are based, for example, on molybdenum applied by means of wire flame spraying on the wear-resistant coating. Here the wear-resistant coating is activated by a blasting process prior thereto.

Furthermore, a running-in layer of an AlCuFe-alloy can be applied to a CKS®-wear-resistant coating by thermal spraying. However, a galvanic intermediate layer has to be applied to the CKS®-wear-resistant coating first.

However, the running-in and wear properties of common piston rings with a wear-resistant coating based on chrome and a running-in layer applied on top thereof still require an improvement.

The task of the present invention is to provide a piston ring with improved running-in and wear behavior as well as a method for the production thereof.

According to a first embodiment of the invention a piston ring is provided, comprising:
a ring body;
an adhesive promoter layer of a Ni-alloy applied to the bearing surface of the ring body by thermal spraying;
a wear-resistant coating of a Mo-alloy with CrC, WC, MoC applied to the adhesive promoter layer by thermal spraying; and
a running-in layer of an AlCu-alloy or Ni-graphite-alloy applied to the wear-resistant coating by thermal spraying.

The piston ring according to the invention, by the use of three different functional layers, provides a new and advantageous combination of wear-resistance (by the wear-resistant coating), favorable running-in properties (by the running-in layer) as well as an increased adhesion/cohesion (by the adhesion layer). It is not necessary to rework or finish running-in layer, but it gets its final form by the friction wear occurring in the running-in phase. The wear-resistant coating prevents excessive wear under extreme operating conditions of the engine. The adhesive promoter layer provides for an optimum attachment of the layers on the bearer or ring body.

Preferably the adhesive promoter layer, the wear-resistant coating and the running-in layer are applied in oversprayed form.

Preferably the ring body comprises gas discharge slots having a bevel at its edges.

Preferably the bevel has an angle of 30° to 70°. Preferably the bevel has a width of 0.5 to 2.0 mm.

According to another aspect of the invention a method of the production of a piston ring is provided according to the first embodiment of the invention, comprising:
providing a ring body;
thermal spraying of an adhesive promoter layer of a Ni-alloy on the bearing surface of the ring body;
thermal spraying of a wear-resistant coating of a Mo-alloy with CrC, WC, MoC on the adhesive promoter layer; and
thermal spraying of a running-in layer of an AlCu-alloy or Ni graphite-alloy on the wear-resistant coating.

The adhesive promoter layer, the wear-resistant coating and the running-in layer are preferably applied in oversprayed form.

Preferably, the thermal spraying includes the following coating methods:
an arc wire coating method;
a flame coating method;
atmospheric plasma spraying, APS; and
high velocity oxy-fuel spraying, HVOF.

Preferably, the method comprises further:
providing to the flank of the ring body with a bevel at its edges, prior to spraying of the adhesive promoter layer.

If the ring body has gas discharge slots, the method preferably comprises further:
providing the gas discharge slots with a bevel at its edges, prior to spraying of the adhesive promoter layer.

Preferably, the bevel has an angle of 30° to 70°. Further preferably, the bevel has a width of 0.5 to 2.0 mm.

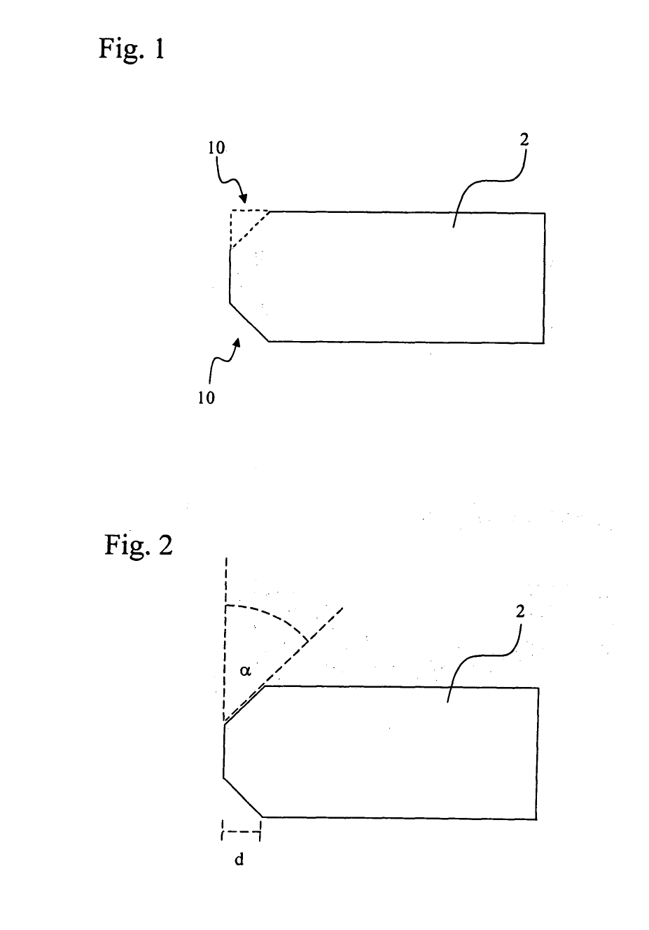

FIG. 1 shows the step of the edge trimming or beveling of the piston ring;

FIG. 2 schematically shows angle and width of the bevel;

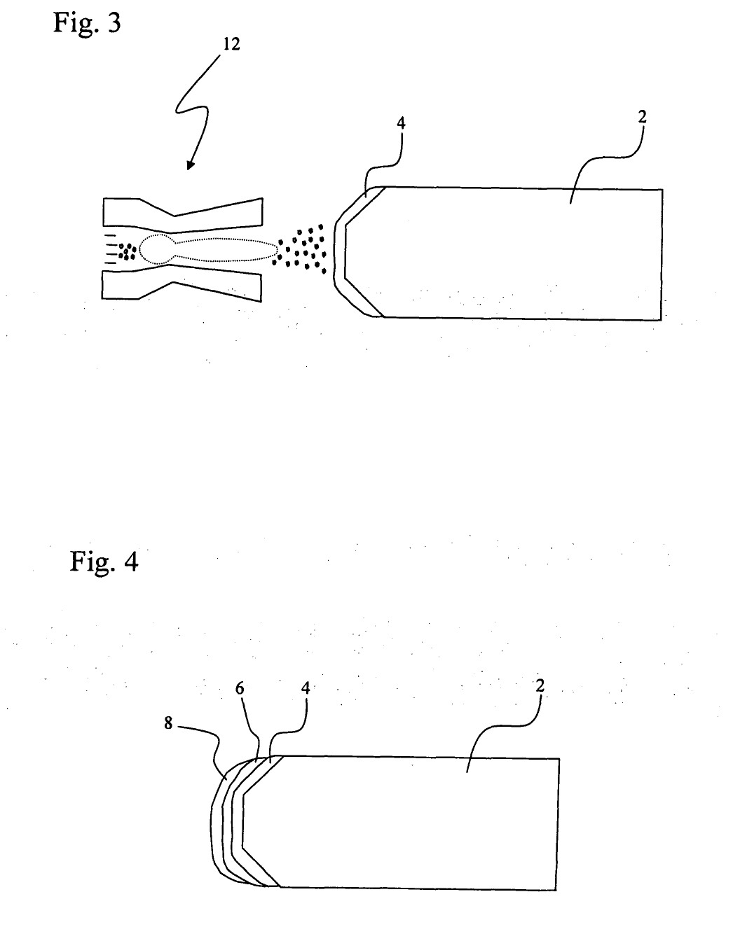

FIG. 3 shows the step of spraying of the adhesive promoter layer; and

FIG. 4 shows the completely coated piston ring according to the invention.

Coatings on the bearing surfaces of piston rings need, in addition to a good and temperature-resistant attachment (adhesion) to the carrier and a good and temperature-resistant bonding within the layer (cohesion), also to be wear-resistant in the surface area being in contact with the cylinder wall. Beyond that, its own or inherent wear in the running-in phase should be sufficient for an adequate adjustment to the counter surface. Beyond that, these layers should be highly resistant to breakouts and also exhibit no or only very slight fatigue even after long periods of use.

Hence, the underlying object of the present invention is to provide the bearing surfaces of piston rings with wear-resistant layers applied by a flame spraying method, which can withstand the extreme loads, but at the same time show a good running-in behavior. The method of the production of the layers should be as simple as possible and cost-saving, and above all it should enable to produce the wear-resistant coatings with properties adjusted to the respective use case.

According to the invention this job is solved in the first embodiment by a coating which consists of at least three superposed different sprayed layers: an adhesive promoter layer, a wear-resistant coating on top thereof, and an exterior running-in layer. Adhesion and cohesion can be further improved by suitable beveling of edges at ring flank and gas discharge slots prior to the coating.

In FIG. 1 is shown in a cross section view how the piston ring is beveled. On the bearing surface side (on the left in the figure) the edges of the piston ring 2 can according to the invention be provided with a bevel 10 prior to the coating. The angle α of the bevel 10 can according to the invention be from 30° and 70°, wherein in FIG. 2 a corner of 45° is shown as example. Furthermore, according to different embodiments of the invention the bevel 10 can have a width d of 0.5 up to 2 mm. The beveling of edges is an optional step in the production of the piston ring and the bevel is an optional characteristic of the finished piston ring according to the invention, respectively. The beveling can be carried out with every suitable known method.

FIG. 3 shows in a cross section view the step of the application of the first layer of the coating. An adhesive promoter layer 4 is applied on the ring body 2. According to the invention this is accomplished by means of a thermal spraying method, including high velocity flame spraying (high velocity oxy-fuel spraying, HVOF), atmospheric plasma spraying (APS), arc wire or wire flame coating method. This is illustrated by a HVOF arrangement 12 as an example. The adhesive promoter layer 4 is a nickel-alloy.

In further steps (not shown in the figures) a wear-resistant coating as well as a running-in layer are applied above the adhesive promoter layer. This can be performed in the same manner as the application of the adhesive promoter layer by one of the above mentioned thermal spraying methods, wherein also different methods can be used for respective different layers. The layer design is FF; that means oversprayed.

According to the first embodiment the wear-resistant coating of the invention is a molybdenum-alloy with chrome carbide CrC, wolfram carbide WC or molybdenum carbide MoC.

The running-in layer applied at last is not reworked on its surface, but rather obtains its final form during the running-in phase of the engine through friction wear.

In FIG. 4 the finished piston ring according to the first embodiment of the invention is shown in a cross section view, comprising the ring body 2, the adhesive promoter layer 4, the wear-resistant coating 6 and the running-in layer 8.

According to a second embodiment of the present invention a piston ring comprises a ring body, a wear-resistant coating applied on the bearing surface of the ring body, and a running-in layer applied on the wear-resistant coating. The running-in layer comprises nickel-graphite (Ni—C-alloy). The piston ring is preferably a large-bore piston ring for an internal combustion engine.

The piston ring according to the second embodiment of the invention by the use of the two different functional layers provides a new and advantageous combination of wear-resistance (by the wear-resistant coating) and favorable running-in qualities (by the running-in layer of nickel graphite). It is not required to rework or finish the running-in layer, but it obtains its final form through the friction wear occurring in the running-in phase. The wear-resistant coating prevents excessive wear under extreme operating conditions of the engine.

Preferably, the wear-resistant coating comprises hard chrome, chrome with aluminum oxide ceramics (e.g., CKS® of the company Federal Mogul) or chrome with micro diamond (e.g., GDC® of the company Federal Mogul).

Preferably the running-in layer has a layer thickness of 20 to 400 μm. Furthermore, preferably the running-in layer has a graphite content of 10 to 40 Vol.-%.

According to a further aspect of the invention a method of the production of a piston ring according to the second embodiment of the invention is provided. It comprises the steps:
providing a ring body;
applying a wear-resistant coating on the bearing surface of the ring body;
activating the wear-resistant coating; and
applying a running-in layer on the wear-resistant coating.

Here the running-in layer comprises nickel graphite.

Preferably, the applying of the wear-resistant coating is performed by a thermal spraying method. Preferably, the thermal spraying method is atmospheric plasma spraying (APS, e.g., MKP) or high velocity oxy-fuel flame spraying (HVOF, e.g., MKJet® of the company Federal Mogul).

Preferably, the wear-resistant coating comprises hard chrome, chrome with aluminum oxide ceramics (e.g., CKS® of the company Federal Mogul) or chrome with micro diamond (e.g., GDC® of the company Federal Mogul).

The wear-resistant coating is preferably activated by a blasting process or thermally.

The applying of the running-in layer is preferably performed by a thermal coating method. Preferably, the thermal coating method is atmospheric plasma spraying (APS, e.g., MKP) or high velocity oxy-fuel flame spraying (HVOF, e.g., MKJet® of the company Federal Mogul).

Preferably, the running-in layer has a layer thickness of 20 to 400 μm. Furthermore, preferably the running-in layer has a graphite content of 10 to 40 Vol.-%.

What is claimed is:

1. A piston ring, comprising:
a ring body;
an adhesive promoter layer of a Ni-alloy applied to the bearing surface of the ring body by thermal spraying;
a wear-resistant coating of a Mo-alloy with CrC, WC, MoC applied to the adhesive promoter layer by thermal spraying;
and a running-in layer of an AlCu-alloy or Ni graphite-alloy applied to the wear-resistant coating by thermal spraying.

2. Piston ring according to claim 1, wherein the adhesive promoter layer, the wear-resistant coating and the running-in layer are applied in oversprayed form.

3. Piston ring according to claim 1, wherein the flank of the ring body has a bevel at their edges.

4. Piston ring according to claim 1, wherein the ring body has gas discharge slots having a bevel at its edges.

5. Piston ring according to claim 3, wherein the bevel has an angle of 30° to 70°.

6. Piston ring according to claim 5, wherein the bevel has a width of 0.5 to 2.0 mm.

7. Method for the production of a piston ring, comprising:
providing a ring body;
thermal spraying of an adhesive promoter layer of a Ni-alloy on the bearing surface of the ring body;
thermal spraying of a wear-resistant coating of Mo-alloy with CrC, WC, MoC on the adhesive promoter layer; and
thermal spraying of a running-in layer of an AlCu-alloy or Ni graphite-alloy on the wear-resistant coating.

8. Method according to claim 7, wherein the adhesive promoter layer, the wear-resistant coating and the running-in layer are applied in oversprayed form.

9. Method according to claim 7, wherein the thermal spraying is selected from a group consisting of at least one of:
an arc wire coating method;
a wire flame coating method;
atmospheric plasma spraying, APS; and
high velocity oxy-fuel flame spraying, HVOF.

10. Method according to claim 7, further comprising:
providing the flank of the ring body with a bevel at its edges, prior to spraying of the adhesive promoter layer.

11. Method according to claim 7 one, wherein the ring body has gas discharge slots, further comprising:
providing the gas discharge slots with a bevel at their edges, prior to spraying of the adhesive promoter layer.

12. Method according to claim 10, wherein the bevel has an angle of 30° to 70°.

13. Method according to claim 12, wherein the bevel has a width of 0.5 to 2.0 mm.

14. Piston ring, comprising a ring body, a wear-resistant coating applied to the bearing surface of the ring body and a running-in layer applied to the wear-resistant coating, and wherein the running-in layer comprises nickel graphite.

15. Piston ring according to claim 14, wherein the wear-resistant coating comprises hard chrome, chrome with aluminium oxide ceramics or chrome with micro diamond.

16. Piston ring according to claim 14, wherein the running-in layer has a layer thickness of 20 to 400 μm.

17. Piston ring according to claim 16, wherein the running-in layer has a graphite content of 10 to 40 Vol.-%.

18. Method for the production of a piston ring, comprising the steps:
providing a ring body;
applying a wear-resistant coating to the bearing surface of the ring body;
activating the wear-resistant coating; and
applying a running-in layer to the wear-resistant coating; and wherein the running-in layer comprises nickel graphite.

19. Method according to claim 18, wherein the applying of the wear-resistant coating is performed by a thermal spraying method.

20. Method according to claim 19, wherein the applying of the wear-resistant coating is performed by atmospheric plasma spraying or high velocity oxy-fuel flame spraying.

21. Method according to claim 18, wherein the wear-resistant coating comprises hard chrome, chrome with aluminium oxide ceramics or chrome with micro diamond.

22. Method according to claim 18, wherein the wear-resistant coating is activated by a blasting process or thermally.

23. Method according to claim 18, wherein the applying of the running-in layer is performed by a thermal coating method.

24. Method according to claim 18, wherein the applying of the running-in layer is performed by plasma spraying or powder flame spraying.

25. Method according to claim 18, wherein the running-in layer has a layer thickness of 20 to 400 μm.

26. Method according to claim 18, wherein the running-in layer has a graphite content of 10 to 40 Vol.-%.

27. The piston ring according to claim 4, wherein the bevel has an angle of 30° to 70°.

28. The piston ring according to claim 27, wherein the bevel has a width of 0.5 to 2.0 mm.

29. The method according to claim 11, wherein the bevel has an angle of 30° to 70°.

30. The method according to claim 11, wherein the bevel has a width of 0.5 to 2.0 mm.
